(19) United States
(12) Patent Application Publication
(10) Pub. No.: US 2018/0006574 A1
(43) Pub. Date: Jan. 4, 2018

(54) TIME-INTERLEAVING CONVERTER AND CONTROL METHOD THEREOF

(71) Applicants: Kwang Ho YOON, Seongnam-si (KR); WooJae CHOI, Anyang-si (KR)

(72) Inventors: Kwang Ho YOON, Seongnam-si (KR); WooJae CHOI, Anyang-si (KR)

(73) Assignee: Silicon Mitus, Inc., Seongnam-si (KR)

(21) Appl. No.: 15/638,814

(22) Filed: Jun. 30, 2017

(30) Foreign Application Priority Data
Jul. 4, 2016 (KR) 10-2016-0084436

(51) Int. Cl. H02M 7/48; H02M 3/337; H02M 3/335; H02P 6/08; H02M 3/158; H02M 1/00

(52) U.S. Cl. CPC H02M 7/48; H02P 6/085; H02M 7/4826; H02M 3/1582; H02M 3/3376; H02M 3/33592; H02M 2001/007

(57) ABSTRACT

A converter that may include: a power stage configured to include at least one inductor and a plurality of switching devices, and configured to be able to operate in a buck mode, a boost mode, or a buck-boost mode according to the control; and a controller configured to apply, to the power stage, two or more operation modes selected from the buck mode, the boost mode, or the buck-boost mode, and configured to periodically change the operation mode of the power stage.

### CROSS REFERENCE TO RELATED APPLICATION

This application claims priority from Korean Patent Application No. 10-2016-0084436, filed on Jul. 4, 2016, which is hereby incorporated by reference for all purposes as if fully set forth herein.

### BACKGROUND OF THE INVENTION

The present invention relates to a converter for converting power.

Buck-type converters and boost-type converters are widely known as switched-mode converters that convert power by using switching devices (e.g., power semiconductors).

Buck-type converters are also known as step-down converters because they reduce an output voltage to be lower than an input voltage and then output the same. In the buck-type converters, a ratio of the input voltage to the output voltage is proportional to a duty cycle (D) of the switching device.

Boost-type converters are also called step-up converters because they increase an output voltage to be higher than an input voltage and then output the same. In the boost-type converters, a ratio of the input voltage to the output voltage is, in general, inversely proportional to (1-D).

The buck-type converters are used in an application in which the output voltage is lower than the input voltage, and the boost-type converters are used in an application in which the output voltage is higher than the input voltage. However, when a magnitude relationship between the input voltage and the output voltage is not clear, or when the output voltage fluctuates from a voltage lower than the input voltage to a voltage higher than the input voltage, the buck-type converters or the boost-type converters cannot be stably used.

Although buck-boost-type converters that are different from the buck-type converters and the boost-type converters can be alternatively applied to the applications above, the buck-boost-type converters have lower power conversion efficiency than that of the buck-type converters or the boost-type converters.

### SUMMARY OF THE INVENTION

In this background, an objective of the present invention is to provide a converter technology that can be applied regardless of the ratio of an input voltage to an output voltage.

In order to accomplish the above objective, in one aspect, the present invention provides a converter that may include: a power stage configured to include at least one inductor and a plurality of switching devices, and further configured to be able to operate in a buck mode, a boost mode, or a buck-boost mode according to the control; and a controller configured to apply two or more operation modes selected from the buck mode, the boost mode, or the buck-boost mode to the power stage, and configured to periodically change the operation mode of the power stage.

According to another aspect, the present invention provides a converter that may include: a power stage configured to include an inductor, a first switching device configured to have one side connected to an input voltage and the other side connected to the inductor, a second switching device configured to have one side connected to an output voltage and the other side connected to the inductor, a third switching device configured to have one side connected to the first switching device and the inductor and the other side connected to a low-voltage line, and a fourth switching device configured to have one side connected to the second switching device and the inductor and the other side connected to the low-voltage line; and a controller configured to control the power stage in two or more operation modes selected from a buck mode, a boost mode, or a buck-boost mode, and configured to periodically change the operation mode of the power stage.

According to another aspect thereof, the present invention provides a method for controlling a converter including at least one inductor and a plurality of switching devices, which may include: a first control step of controlling the converter in one of a buck mode, a boost mode, or a buck-boost mode in a first time period; a second control step of controlling the converter in another of the buck mode, the boost mode, or the buck-boost mode in a second time period; and a repetition step of repeating the first control step and the second control step at a constant period.

According to the embodiments described above, converters having the same structure can be applied to various applications regardless of the ratio of an input voltage to an output voltage, and the converters of the present invention can provide higher power conversion efficiency than other types of converters.

### BRIEF DESCRIPTION OF THE DRAWINGS

The above and other objects, features, and advantages of the present invention will be more apparent from the following detailed description taken in conjunction with the accompanying drawings, in which:

FIG. 1 is a configuration diagram of a converter, according to an embodiment;

FIG. 2 is a configuration diagram of an example of a power stage;

FIG. 3 is a diagram showing on/off control of switching devices in a buck mode;

FIG. 4 is a diagram showing on/off control waveforms for each switching device in a buck mode;

FIG. 5 is a diagram showing on/off control of switching devices in a boost mode;

FIG. 6 is a diagram showing on/off control waveforms for each switching device in a boost mode;

FIG. 7 is a diagram showing on/off control of switching devices in a buck-boost mode;

FIG. 8 is a diagram showing on/off control waveforms for each switching device in a buck-boost mode;

FIG. 9 is a diagram showing operation modes, on a time axis, applied to a power stage in a time-interleaving manner;

FIG. 10 is a time diagram to explain the control of the buck mode and the boost mode in a time-interleaving manner;

FIG. 11 is a diagram showing an output voltage range of a time-interleaving converter;

FIG. 12 is a diagram showing signal and inductor current waveforms when the buck mode and the boost mode are controlled in a time-interleaving manner;

FIG. 13 is a time diagram to explain the control of three operation modes in a time-interleaving manner; and

FIG. 14 is a flowchart showing a control method of a converter, according to an embodiment.

### DETAILED DESCRIPTION OF THE EXEMPLARY EMBODIMENTS

Hereinafter, embodiments of the present invention will be described in detail with reference to the accompanying drawings. In adding reference numerals to elements in each drawing, the same elements will be designated by the same reference numerals, if possible, although they are shown in different drawings. Further, in the following description of the present invention, a detailed description of known functions and configurations incorporated herein will be omitted when it is determined that the description may make the subject matter of the present invention rather unclear.

In addition, terms, such as first, second, A, B, (a), (b) or the like may be used herein when describing components of the present invention. These terms are merely used to distinguish one structural element from other structural elements, and a property, an order, a sequence and the like of a corresponding structural element are not limited by the term. It should be noted that if it is described in the specification that one component is “connected,” “coupled” or “joined” to another component, a third component may be “connected,” “coupled,” and “joined” between the first and second components, although the first component may be directly connected, coupled or joined to the second component.

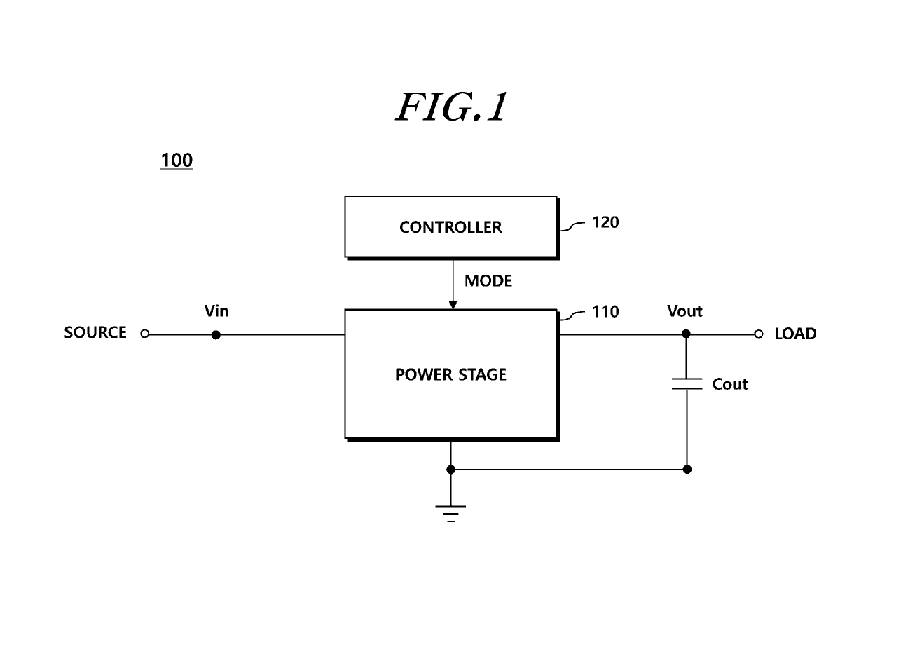

FIG. 1 is a configuration diagram of a converter, according to an embodiment.

Referring to FIG. 1, the converter (100) may include a power stage (110), a controller (120), an output capacitor (Cout), and the like.

The converter (100) may operate in a buck mode, a boost mode, or a buck-boost mode.

The power stage (110) may include at least one inductor and a plurality of switching devices (e.g., power semiconductors). The power stage (110) may control the switching devices to be turned on/off in order to thereby convert an input voltage (Vin) supplied from a power source into an output voltage Vout to then be supplied to a load. Power semiconductors, such as a MOSFET (Metal Oxide Silicon Field Effect Transistor) or a diode, may be used as the switching devices. Furthermore, other types of power semiconductors, such as a BJT (Bipolar Junction Transistor), may be applied.

The controller (120) may control the power stage (110) in a buck mode, a boost mode, or a buck-boost mode.

The controller (120) may apply, to the power stage (110), two or more operation modes selected from the buck mode, the boost mode, or the buck-boost mode, and may periodically change the operation mode of the power stage (110).

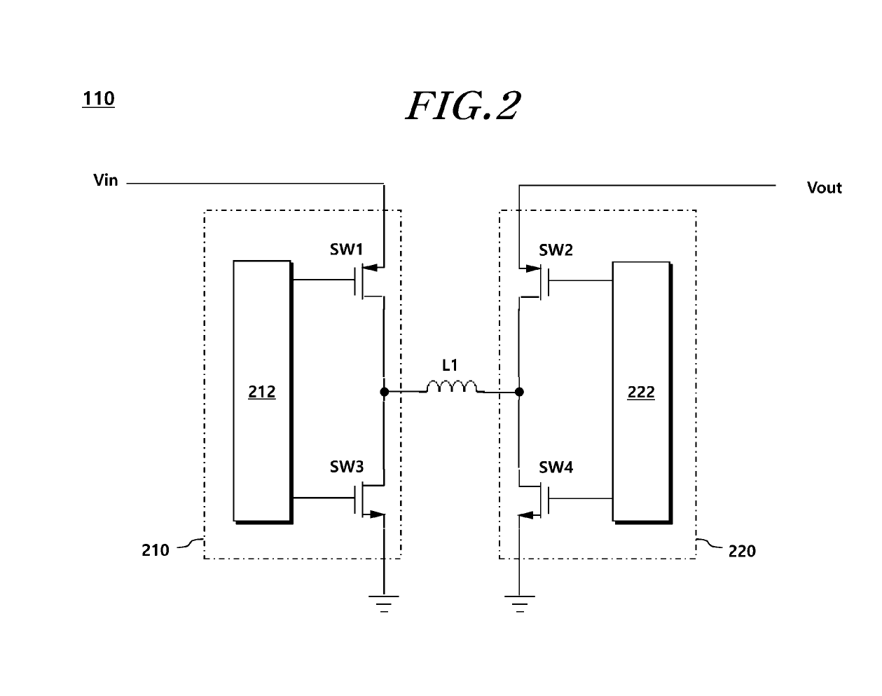

FIG. 2 is a configuration diagram of an example of the power stage.

Referring to FIG. 2, the power stage (110) may include an inductor (L1), a first switching unit (210) connected to one side of the inductor (L1), and a second switching unit (220) connected to the other side of the inductor (L1).

The first switching unit (210) may include a first switching device (SW1) that is disposed to have one side connected to an input voltage (Vin) and the other side connected to the inductor (L1), and a third switching device (SW3) that is disposed to have one side connected to the first switching device (SW1) and the inductor (L1) and the other side connected to a low-voltage line (e.g., a ground). In terms of position, the first switching device (SW1) may be positioned between an input node to which the input voltage (Vin) is transferred and one side of the inductor (L1), and the third switching device (SW3) may be positioned between the low-voltage line (e.g., a ground) and one side of the inductor (L1). In addition, a first driver (212) for controlling the first switching device (SW1) and the third switching device (SW3) to be turned on/off may be disposed in the first switching unit (210).

The second switching unit (220) may include a second switching device (SW2) that is disposed to have one side connected to the output voltage (Vout) and the other side connected to the inductor (L1), and a fourth switching device (SW4) that is disposed to have one side connected to the second switching device (SW2) and the inductor (L1) and the other side connected to a low-voltage line. In terms of position, the second switching device (SW2) may be positioned between an output node to which the output voltage (Vout) is supplied and the other side of the inductor (L1), and the fourth switching device (SW4) may be positioned between the low-voltage line and the other side of the inductor (L1). In addition, a second driver (222) for controlling the second switching device (SW2) and the fourth switching device (SW4) to be turned on/off may be disposed in the second switching unit (220).

The power stage (110) may operate in the buck mode, the boost mode, or the buck-boost mode according to the control of the switching devices (SW1) to (SW4).

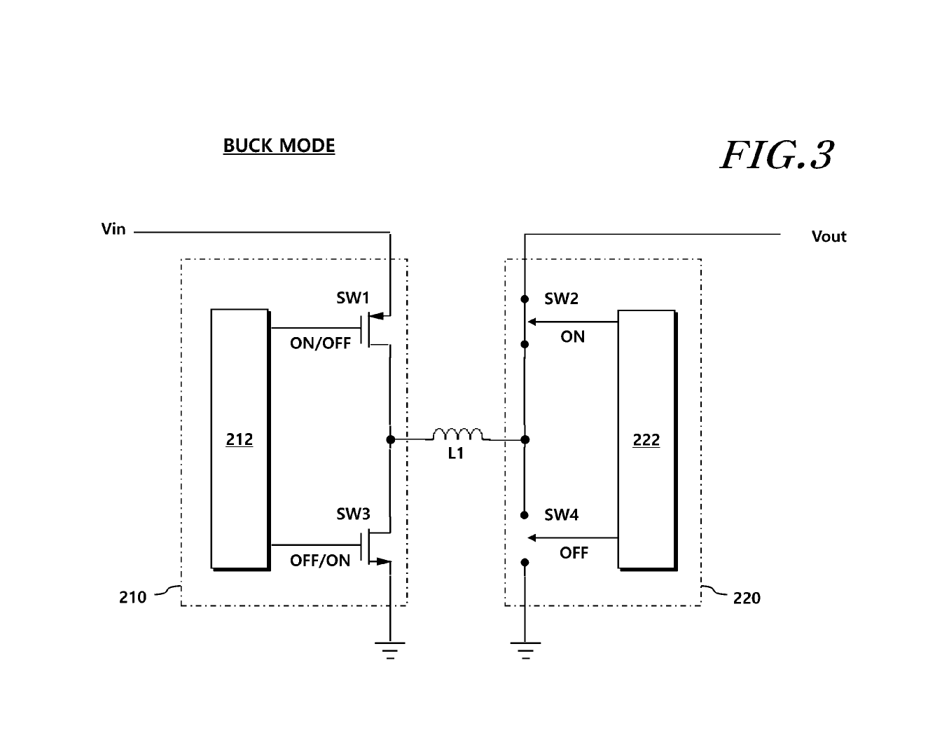

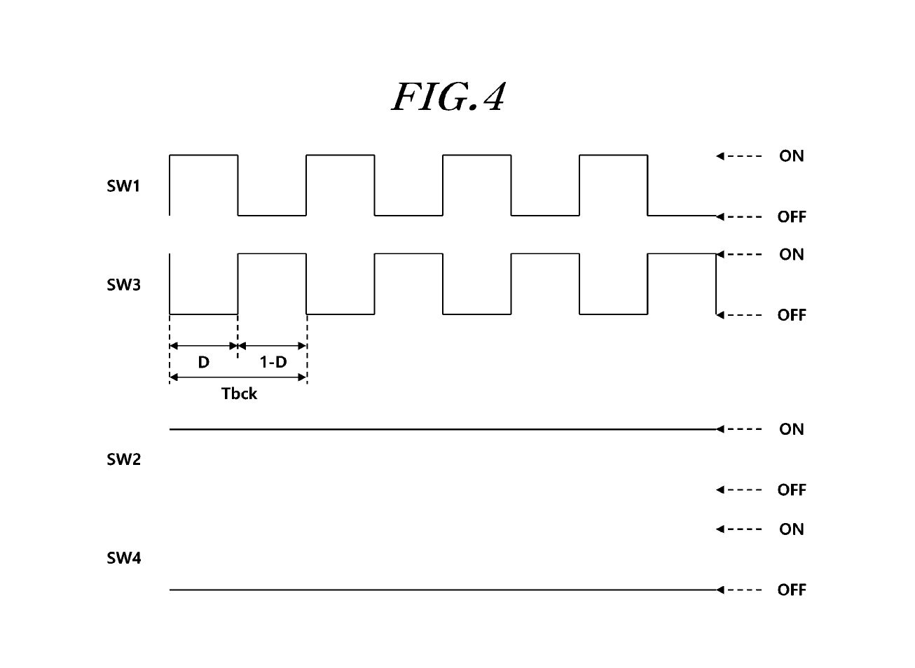

FIG. 3 is a diagram showing on/off control of switching devices in the buck mode, and FIG. 4 is a diagram showing on/off control waveforms for each switching device in the buck mode.

In the buck mode, the switching devices (SW2) and (SW4) of the second switching unit (220) may be turned on or off all the time. For example, the second switching device (SW2) may be turned on all the time and the fourth switching device (SW4) may be turned off all the time in the buck mode. For this control, the second driver (222) may continue to supply a switch-on voltage (ON) to the gate-source of the second switching device (SW2), and may continue to supply a switch-off voltage (OFF) to the gate-source of the fourth switching device (SW4) in the buck mode.

In the buck mode, the switching devices (SW1) and (SW3) of the first switching unit (210) may be turned on and off in sequence at every period to allow the converter to operate as a buck converter.

For example, in a buck mode control cycle (Tbck), the first switching device (SW1) may be turned on and the third switching device (SW3) may be turned off in a duty period (D) to allow the inductor (L1) to be connected with a high voltage (input voltage), and the first switching device (SW1) may be turned off and the third switching device (SW3) may be turned off in the rest period (1-D) to allow the inductor (L1) to be connected with a low voltage (ground voltage).

For this control, the first driver (212) may make a control to sequentially turn on and off the first switching device (SW1) and the third switching device (SW3) at every period in the buck mode period.

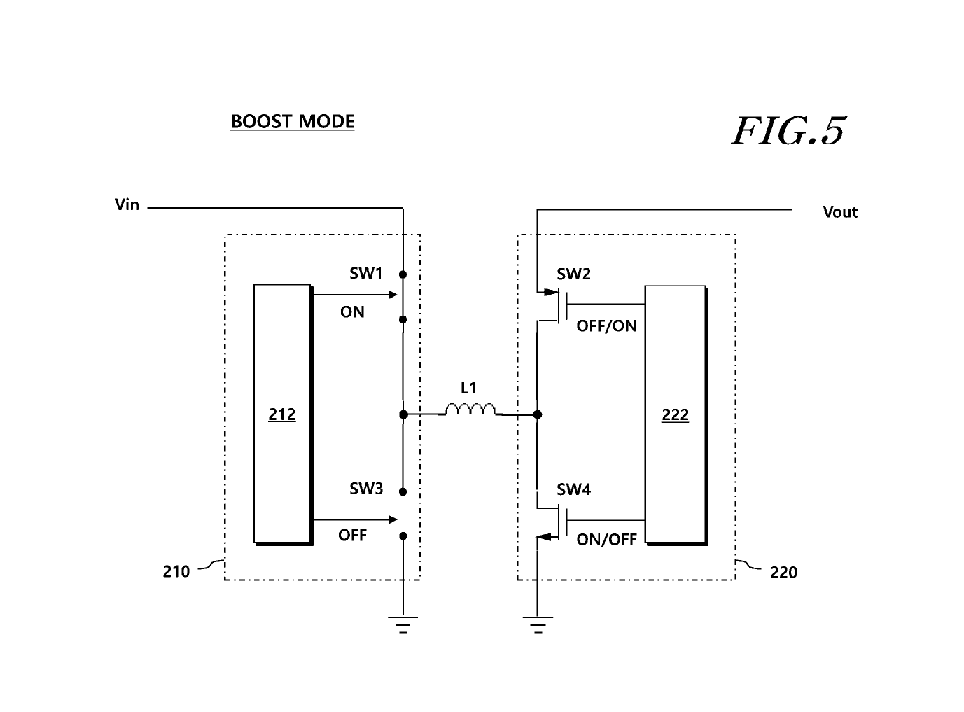

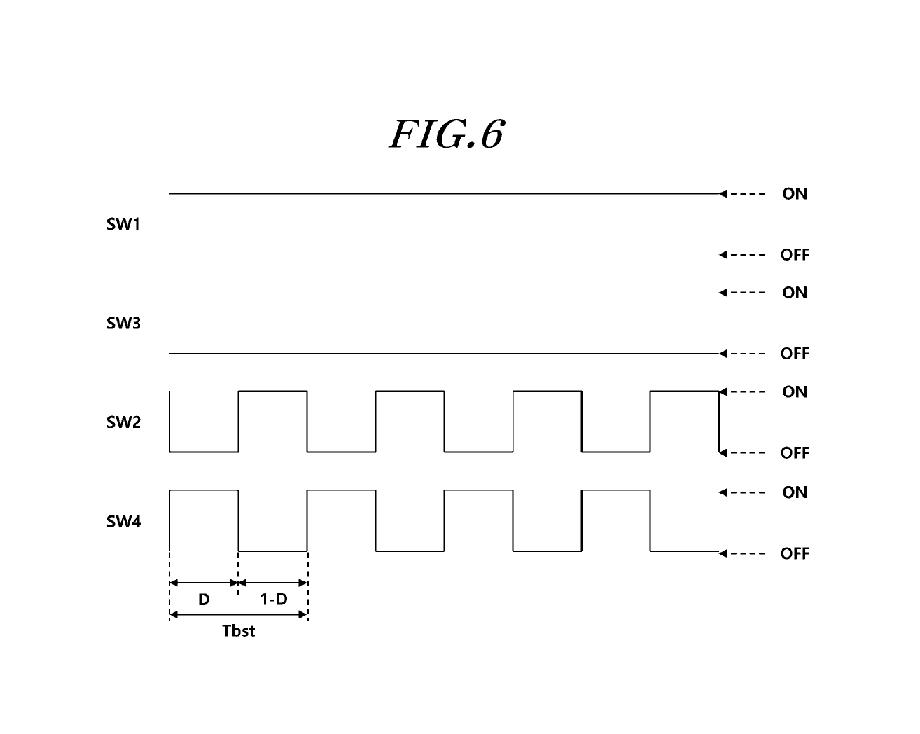

FIG. 5 is a diagram showing on/off control of switching devices in the boost mode, and FIG. 6 is a diagram showing on/off control waveforms for each switching device in the boost mode.

In the boost mode, the switching devices (SW1) and (SW3) of the first switching unit (210) may be turned on or off all the time. For example, the first switching device (SW1) may be turned on all the time and the third switching device (SW3) may be turned off all the time in the boost mode. For this control, the first driver (212) may continue to supply a switch-on voltage (ON) to the gate-source of the first switching device (SW1), and may continue to supply a switch-off voltage (OFF) to the gate-source of the third switching device (SW3) in the boost mode period.

In the boost mode, the switching devices (SW2) and (SW4) of the second switching unit (220) may be turned on and off in sequence at every period to allow the converter to operate as a boost converter.

For example, in a boost mode control cycle (Tbst), the fourth switching device (SW4) may be turned on and the second switching device (SW2) may be turned off in a duty period (D) to build up current in the inductor (L1), and the fourth switching device (SW4) may be turned off and the second switching device (SW2) may be turned on in the rest period (1-D) to transfer the current stored in the inductor (L1) to an output capacitor.

For this control, the second driver (222) may make a control to sequentially turn on and off the second switching device (SW2) and the fourth switching device (SW4) at every period in the boost mode period.

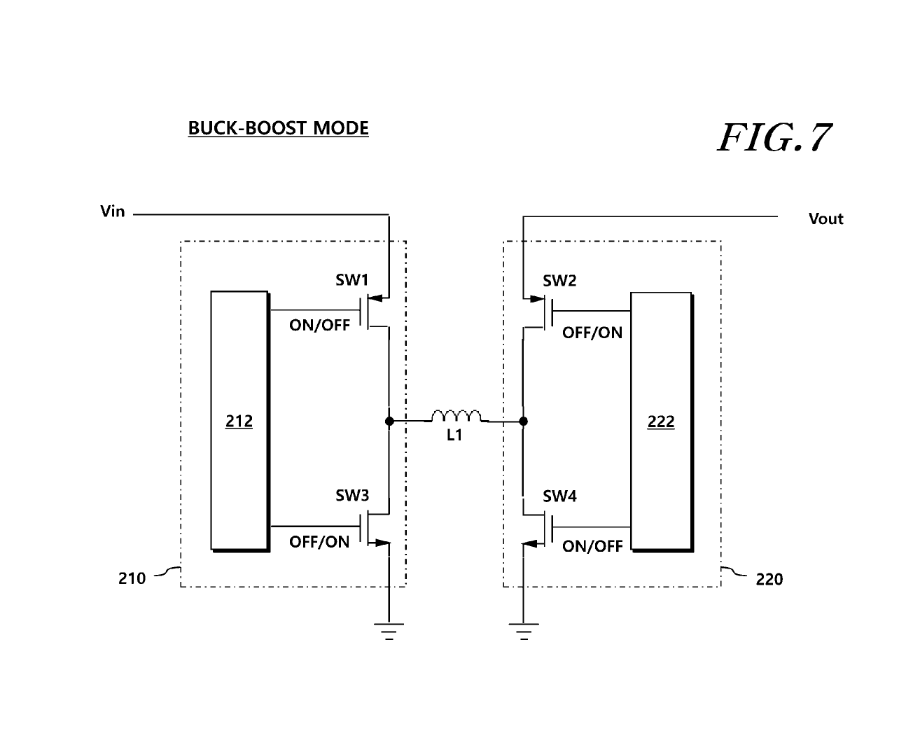

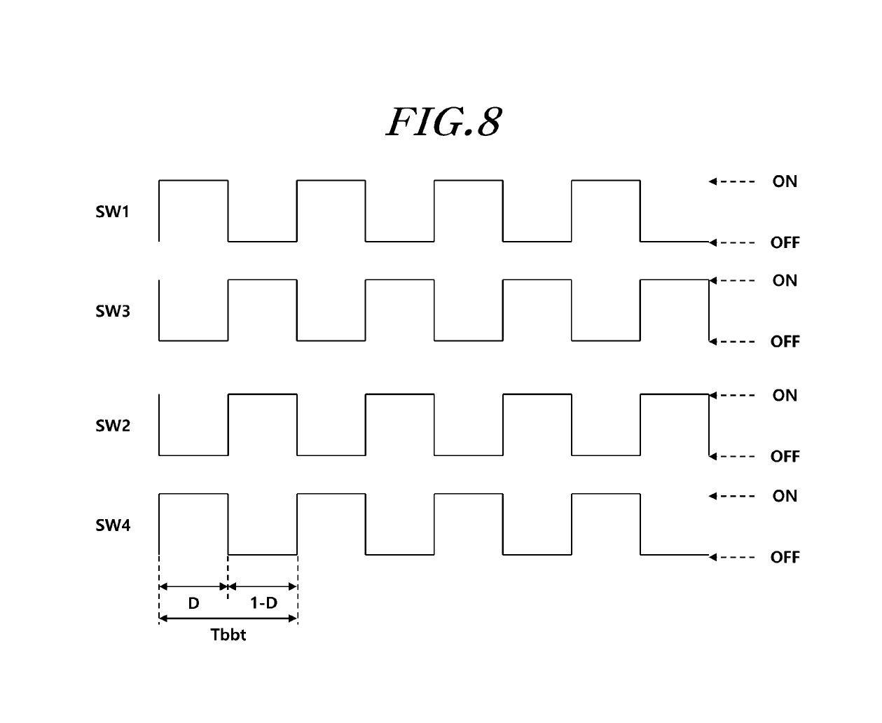

FIG. 7 is a diagram showing on/off control of switching devices in the buck-boost mode, and FIG. 8 is a diagram showing on/off control waveforms for each switching device in the buck-boost mode.

In the buck-boost mode, the first switching device (SW1) and the fourth switching device (SW4) may be synchronized to be turned on or off, and the second switching device (SW2) and the third switching device (SW3) may be synchronized to be turned on or off. The first switching device (SW1) and the second switching device (SW2) may be turned on and off in sequence at every period to operate the converter as a buck-boost converter.

For example, in a buck-boost mode control cycle (Tbbt), the first switching device (SW1) and the fourth switching device (SW4) may be turned on in a duty period (D) to build up current in the inductor (L1), and the first switching device (SW1) and the fourth switching device (SW4) may be turned off, whereas the second switching device (SW2) and the third switching device (SW3) may be turned on in the rest period (1-D) to transfer the current stored in the inductor (L1) to an output capacitor.

Meanwhile, the controller may alternately apply each operation mode to the power stage in a time-interleaving manner.

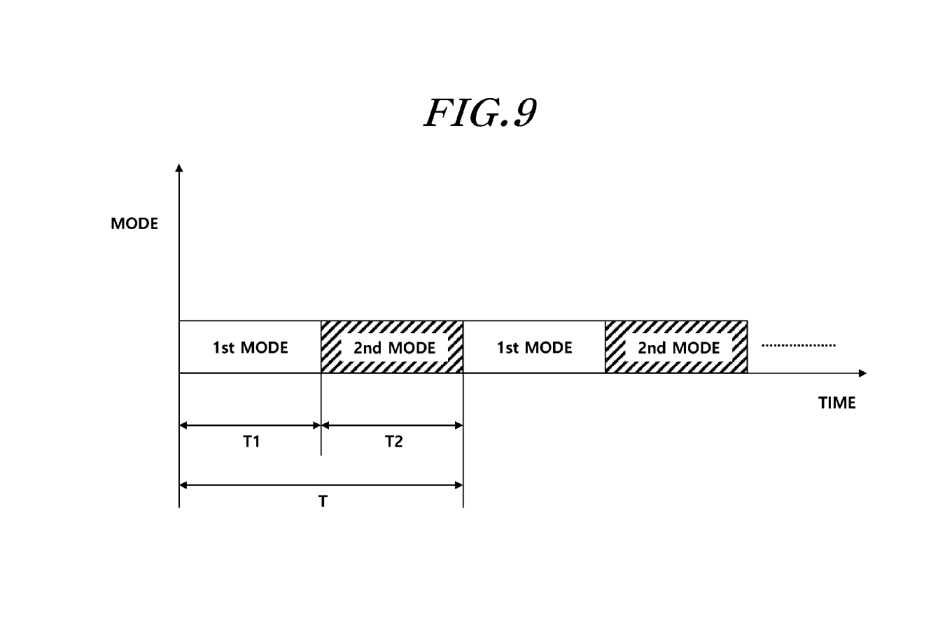

FIG. 9 is a diagram showing operation modes, on a time axis, applied to the power stage in a time-interleaving manner.

Referring to FIG. 9, the controller may periodically change the operation mode of the power stage. For example, the controller may control the power stage by periodically changing its mode into the first mode or the second mode.

The first mode and the second mode may be one of the buck mode, the boost mode, or the buck-boost mode.

The controller may periodically change the operation mode. When a control cycle (T) refers to a cycle in which the same operation mode is repeated, the controller may apply two or more operation modes to the power stage for one control cycle (T).

For example, the controller may operate the power stage in one of the buck mode, the boost mode, or the buck-boost mode in the first time period (T1) of one control cycle (T), and may operate the power stage in another of the buck mode, the boost mode, or the buck-boost mode in the second time period of one control cycle (T).

The controller may operate each operation mode during only one mode control cycle in one control cycle (T). Here, the mode control cycle refers to a cycle in each mode, which corresponds to a buck mode control cycle (see Tbck in FIG. 3), a boost mode control cycle (see Tbst in FIG. 5), or a buck-boost mode control cycle (see Tbbt in FIG. 7).

The controller may make a control to vary the length of a time period during which each operation mode is applied in one control cycle (T). In addition, the controller may variably control the time period during which each operation mode is applied in one control cycle (T).

For example, in FIG. 9, the controller may make a control so that the length of the first time period (T1) during which the first mode is applied and the length of the second time period (T2) during which the second mode is applied are different from each other, or may control the same in a variable manner.

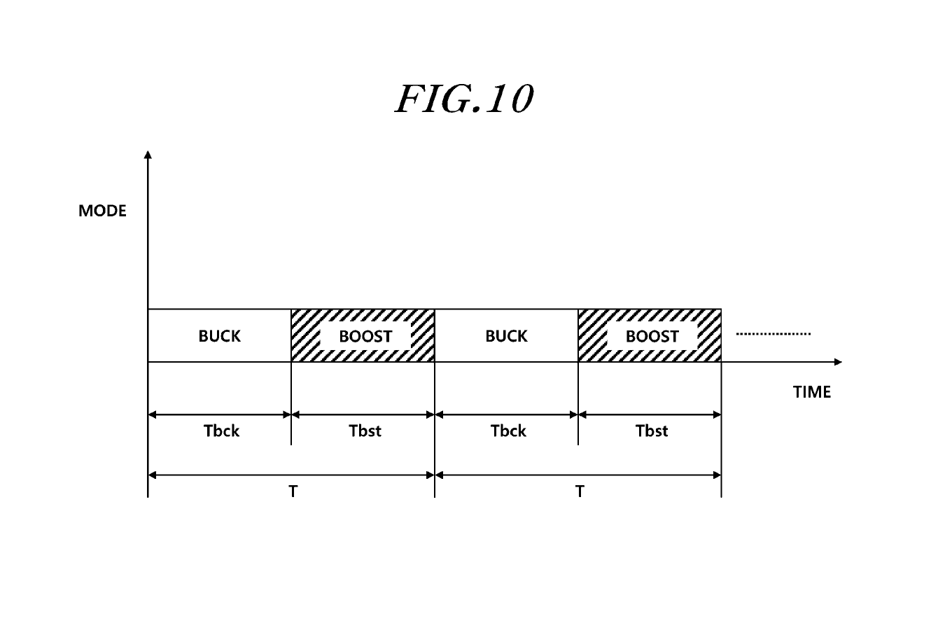

FIG. 10 is a time diagram to explain the control of the buck mode and the boost mode in a time-interleaving manner.

Referring to FIG. 10, one control cycle (T) may be comprised of a first time period corresponding to a buck mode control cycle (Tbck) and a second time period corresponding to a boost mode control cycle (Tbst), and the controller may control the power stage in the buck mode during the first time period, and may control the power stage in the boost mode during the second time period.

The length of the first time period, during which the buck mode is applied, may be different from the length of the second time period during which the boost mode is applied, or they may be the same according to embodiments. FIG. 10 shows an example in which the length of the first time period is equal to the length of the second time period.

The controller may repeatedly change the operation mode of the power stage at every period. For example, the controller may sequentially change the buck mode and the boost mode at every period and may then apply the same to the power stage.

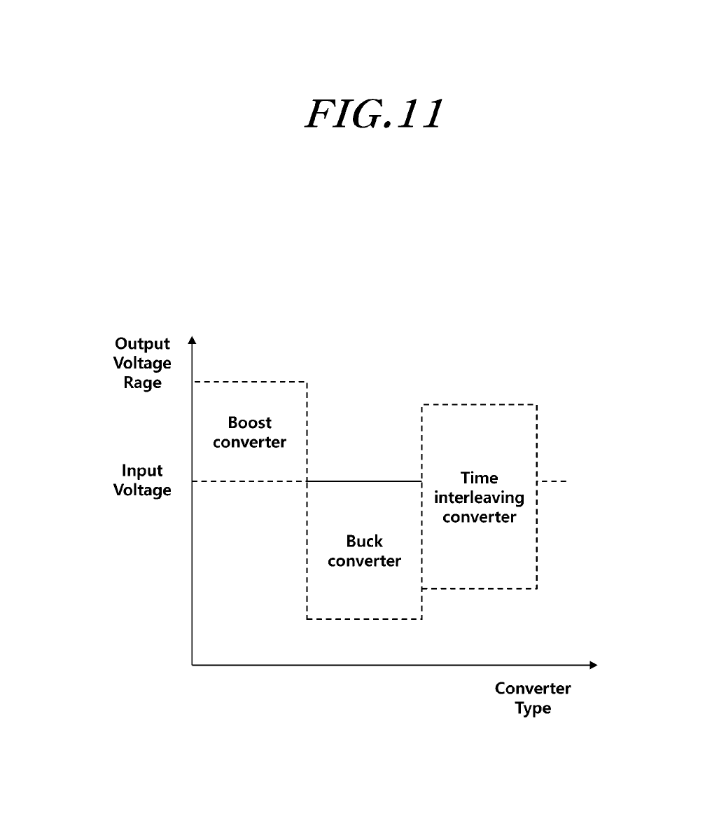

FIG. 11 is a diagram showing an output voltage range of a time-interleaving converter.

Referring to FIG. 11, the output voltage of the boost-type converter is higher than the input voltage thereof. Accordingly, when the output voltage is lower than the input voltage, or when the output voltage fluctuates above or below the input voltage, the boost-type converter cannot be applied. The buck-type converter has a lower output voltage than an input voltage. Accordingly, when the output voltage is higher than the input voltage, or when the output voltage fluctuates above or below the input voltage, the buck-type converter cannot be applied.

On the contrary, the variable range of an output voltage in the time-interleaving converter, according to an embodiment, is broadly distributed above and below an input voltage. More specifically, the lowest voltage in the variable range of an output voltage of the power stage is lower than an input voltage and the highest voltage thereof is greater than the input voltage.

Accordingly, the time-interleaving converter can be efficiently applied to applications in which an output voltage is unclear or to applications in which the variation range of an output voltage spans above and below an input voltage.

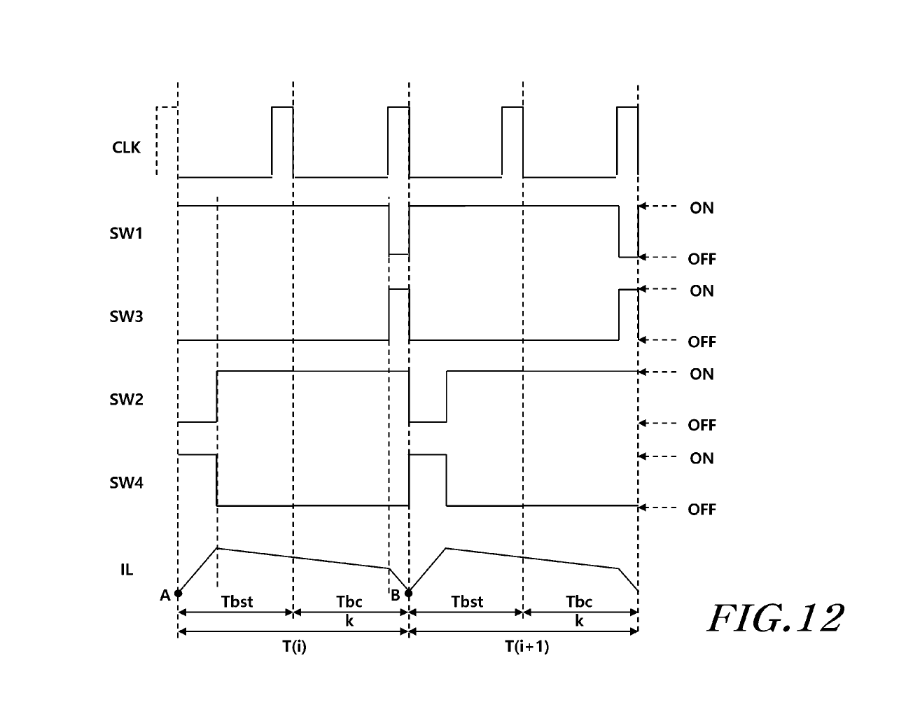

FIG. 12 is a diagram showing signal and inductor current waveforms when the buck mode and the boost mode are controlled in a time-interleaving manner.

The controller may change the operation mode of the power stage according to a clock signal (CLK). Referring to FIG. 12, the controller changes the operation mode of the power stage according to falling edges of the clock signal (CLK).

When the controller applies two operation modes to the power stage, one control cycle (T) may include two clock signals (for example, polling edges of the clock signal), and the controller may change two operation modes in sequence according to the two clock signals.

As another example, the controller may sequentially change selected operation modes at every period of the clock signal. At this time, in the case where three operation modes are selected, one control cycle (T) includes three clock signals (for example, falling edges of the clock signal).

Meanwhile, when a load current is constant, the controller may control a duty cycle of the selected operation mode such that the current (IL) of the inductor at a start point (A) of one control cycle (T(i)) becomes equal to the current (IL) of the inductor at a start point (B) of the next control cycle (T(i+1)).

Referring to FIG. 12, the inductor current (IL) at the start point (A) of the i-th control cycle (T(i)) increases while the fourth switching device (SW4) is turned on and the second switching device (SW2) is turned off according to the booster mode control, wherein the first switching device (SW1) is turned on all the time and the third switching device (SW3) is turned off all the time under the boost mode control. In addition, the inductor current (IL) decreases while the fourth switching device (SW4) is turned off and the second switching device (SW2) is turned on according to the boost mode control, and this reduction state is maintained while the first switching device (SW1) is turned on and the third switching device (SW3) is turned off according to the buck mode control, wherein the second switching device (SW2) is turned on all the time and the fourth switching device (SW4) is turned off all the time in the buck mode control. Substantially, the switch-on/off states of the respective switching devices (SW1) to (SW4) are the same in a period in which the fourth switching device (SW4) is turned off under the boost mode control and in a period in which the first switching device (SW1) is turned on under the buck mode control. When the first switching device SW1 is turned off and the third switching device (SW3) is turned on according to the buck mode control in the last period of the i-th control cycle (T(i)), the inductor current (IL) decreases at a higher slope.

If the duty cycle in the boost mode and the duty cycle in the buck mode are controlled such that the inductor current (IL) at the start point (A) of the i-th control cycle (T(i)) is equal to the inductor current (IL) at the end point (B) of the i-th control cycle (T(i)), the inductor current (IL) is maintained according to the same pattern of control in the next control cycle (T(i+1)) (the (i+1)-th control cycle). In addition, a constant current may be supplied to the load.

Meanwhile, although the controller sequentially applies two operation modes to the power stage in the embodiment described with reference to FIGS. 9 to 12, the controller may sequentially apply three operation modes to the power stage.

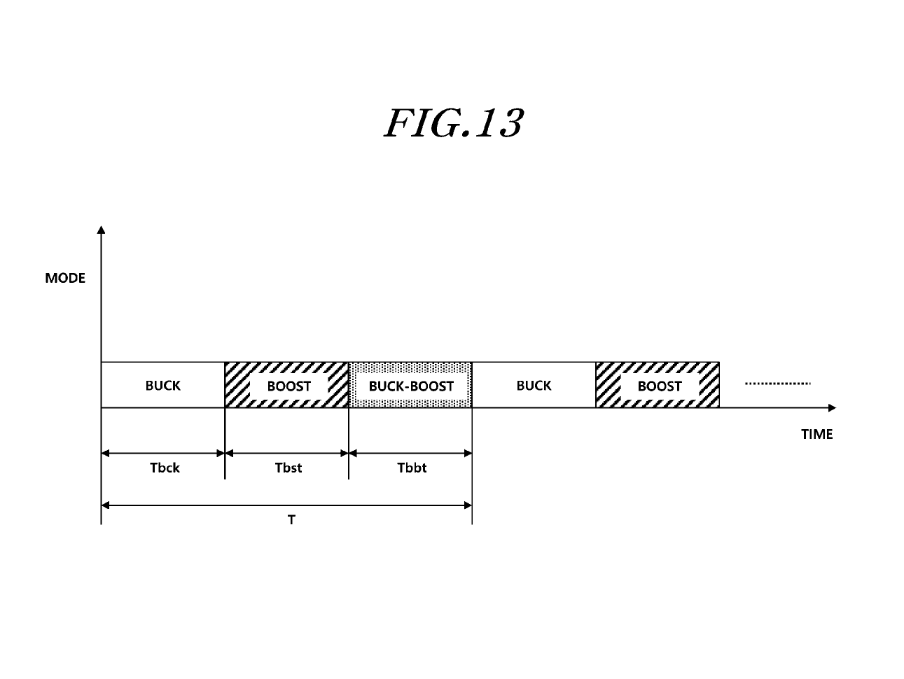

FIG. 13 is a time diagram to explain the control of three operation modes in a time-interleaving manner.

Referring to FIG. 13, the controller may control the power stage while changing the buck mode, the boost mode, and the buck-boost mode in sequence.

The sequence of operation modes applied to the power stage may vary. For example, the controller may control the power stage by changing its operation mode to the boost mode, the buck mode, and then the buck-boost mode.

The controller may control the power stage by sequentially changing two or more operation modes selected from the buck mode, the boost mode, or the buck-boost mode. As described in the previous embodiment, the controller may control the power stage by sequentially changing the buck mode and the boost mode. In addition, the controller may control the power stage by sequentially changing the buck mode, the boost mode, and the buck-boost mode. As another example, the controller may control the power stage by sequentially changing the boost mode and the buck-boost mode, or may control the power stage by sequentially changing the buck mode and the buck-boost mode.

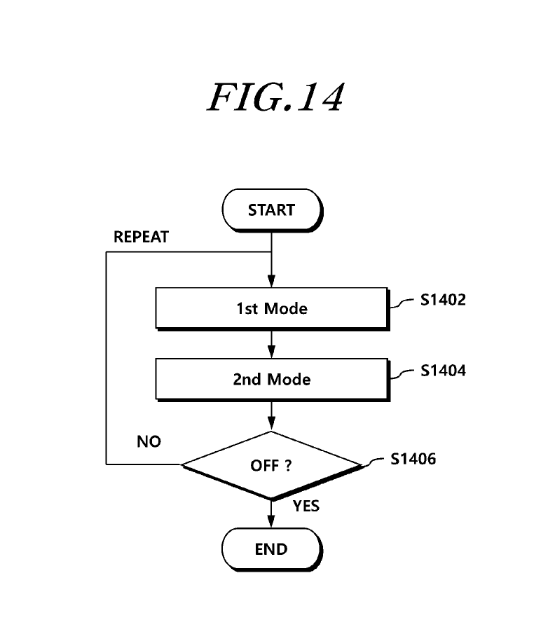

FIG. 14 is a flowchart showing a control method of a converter, according to an embodiment.

Referring to FIG. 14, the converter may be controlled in one of a buck mode, a boost mode, or a buck-boost mode in a first time period (S1402).

Then, the converter may be controlled in another of the buck mode, the boost mode, or the buck-boost mode in a second time period (S1404).

In addition, if the operation of the converter is not terminated (NO in S1406), steps S1402 and S1404 may be repeated at a constant period.

The converter may be operated by switching through three operation modes in sequence, wherein the converter may be controlled in the other of the buck mode, the boost mode, or the buck-boost mode in a third time period after the step S1404.

Further, the converter may repeat the respective steps at a constant period.

An embodiment of the present invention has been described above. According to the embodiment, a converter having the same structure can be applied to various applications regardless of the ratio of an input voltage to an output voltage, and it is possible to obtain higher power conversion efficiency than other types of converters.

In addition, since terms, such as “including,” “comprising,” and “having” mean that one or more corresponding components may exist unless they are specifically described to the contrary, it shall be construed that one or more other components can be included. All the terms that are technical, scientific or otherwise agree with the meanings as understood by a person skilled in the art unless defined to the contrary. Common terms as found in dictionaries should be interpreted in the context of the related technical writings not too ideally or impractically unless the present invention expressly defines them so.

Although a preferred embodiment of the present invention has been described for illustrative purposes, those skilled in the art will appreciate that various modifications, additions and substitutions are possible, without departing from the scope and spirit of the invention as disclosed in the accompanying claims. Therefore, the embodiments disclosed in the present invention are intended to illustrate the scope of the technical idea of the present invention, and the scope of the present invention is not limited by the embodiment. The scope of the present invention shall be construed on the basis of the accompanying claims in such a manner that all of the technical ideas included within the scope equivalent to the claims belong to the present invention.

What is claimed is:

1. A converter comprising:
a power stage configured to include at least one inductor and a plurality of switching devices, and configured to be able to operate in a buck mode, a boost mode, or a buck-boost mode according to the control; and
a controller configured to apply, to the power stage, two or more operation modes selected from the buck mode, the boost mode, or the buck-boost mode, and configured to periodically change the operation mode of the power stage.

2. The converter according to claim 1, wherein a lowest voltage in a variable range of an output voltage of the power stage is lower than an input voltage and a highest voltage thereof is higher than the input voltage.

3. The converter according to claim 1, wherein the controller is configured to:
operate the power stage in one of the buck mode, the boost mode, or the buck-boost mode in a first time period of one cycle;
operate the power stage in another of the buck mode, the boost mode, or the buck-boost mode in a second time period of the one cycle; and
control the first time period and the second time period to be variable.

4. A converter comprising:
a power stage configured to include
an inductor,
a first switching device configured to have one side connected to an input voltage and the other side connected to the inductor,
a second switching device configured to have one side connected to an output voltage and the other side connected to the inductor,
a third switching device configured to have one side connected to the first switching device and the inductor and the other side connected to a low-voltage line, and
a fourth switching device configured to have one side connected to the second switching device and the inductor and the other side connected to the low-voltage line; and
a controller configured to control the power stage in two or more operation modes selected from a buck mode, a boost mode, or a buck-boost mode, and configured to periodically change the operation mode of the power stage.

5. The converter according to claim 4, wherein the controller is configured to:
Keep the second switching device constantly turned on and turn on the first switching device and the third switching device in sequence when controlling the power stage in the buck mode; and
Keep the first switching device constantly turned on and turn on the second switching device and the fourth switching device in sequence when controlling the power stage in the boost mode.

6. The converter according to claim 4, wherein the controller is configured to:
operate the power stage in one of the buck mode, the boost mode, or the buck-boost mode in a first time period of one cycle; and
operate the power stage in another of the buck mode, the boost mode, or the buck-boost mode in a second time period of the one cycle, and
wherein a length of the first time period is equal to a length of the second time period.

7. The converter according to claim 4, wherein the controller is configured to:
change the operation mode of the power stage according to a clock signal; and
control the power stage while sequentially changing the two or more selected operation modes at every period of the clock signal.

8. The converter of claim 4, wherein the controller is configured to control the duty cycle of the selected operation mode such that a current of the inductor at a start point of one cycle is equal to a current of the inductor at a start point of the next cycle when a load current is constant.

9. A method for controlling a converter including at least one inductor and a plurality of switching devices, the method comprising:
a first control step of controlling the converter in one of a buck mode, a boost mode, or a buck-boost mode in a first time period;
a second control step of controlling the converter in another of the buck mode, the boost mode, or the buck-boost mode in a second time period; and
a repetition step of repeating the first control step and the second control step at a constant period.

10. The method according to claim 9, further comprising a third control step of controlling the converter in a remaining one of the buck mode, the boost mode, or the buck-boost mode in a third time period, wherein the first control step, the second control step, and the third control step are repeated at a constant period in the repetition step.
